(19) United States
(12) Patent Application Publication
(10) Pub. No.: US 2025/0287221 A1
(43) Pub. Date: Sep. 11, 2025

(54) METHODS AND SYSTEMS FOR SUPPORTING MULTI-RAT RELAYS IN 5G AND BEYOND NETWORKS

(71) Applicant: INDIAN INSTITUTE OF TECHNOLOGY BOMBAY, Mumbai (IN)

(72) Inventors: Pranav Kumar JHA, Mumbai (IN); Rashmi KAMRAN, Mumbai (IN); Shwetha KIRAN, Mumbai (IN); Abhay KARANDIKAR, Mumbai (IN); Prasanna S. CHAPORKAR, Mumbai (IN)

(73) Assignee: INDIAN INSTITUTE OF TECHNOLOGY BOMBAY, Mumbai (IN)

(21) Appl. No.: 18/773,112

(22) Filed: Jul. 15, 2024

(30) Foreign Application Priority Data
Mar. 7, 2024 (IN) 202423016627

(51) Int. Cl. H04W 16/26; H04W 88/14

(52) U.S. Cl. CPC H04W 16/26; H04W 88/14

(57) ABSTRACT

Embodiments herein disclose methods and systems for interchangeably using 5G NR, LTE eNB and Wireless Local Area Network (WLAN) technologies for access and backhaul links in 5G and beyond networks, which provides greater flexibility for the operators to use non-identical radio technology(ies) for access and backhaul, independent of the backhaul technology used.

### CROSS REFERENCE TO RELATED APPLICATIONS

This application claims priority from IN 202423016627 filed on Mar. 7, 2024 as a patent of addition (Continuation in Part) to IN 201921027924 filed on Jul. 11, 2019.

### TECHNICAL FIELD

Embodiments disclosed herein relate to wireless communication networks and more particularly to providing support for multi-Radio Access Technologies (RATs) in Fifth Generation (5G) and beyond networks.

### BACKGROUND

In general, advanced wireless communication networks (such as the Long-Term Evolution (LTE) network or Fifth Generation (5G) network) can provide a high data rate with the capability of providing diverse services with different Quality of Service (QoS) requirements.

FIGS. 1A and 1B illustrate a wireless communication network in compliance with a standard 3rd Generation Partnership Project (3GPP) specification, wherein the wireless communication network can be an LTE network. The LTE network includes at least one Base Station (also called an eNodeB or eNB), the Evolved Packet Core (EPC) and at least one User Equipment (UE). The LTE network can enable an Internet Protocol (IP) based connectivity between the UE and an external data network. In order to exchange data with the external data network, the UE establishes a direct radio link with the eNB of the LTE network. Further, the eNB communicates with the EPC over the wired backhaul link to exchange the UE data. The EPC connects the UE with the external data network.

In case of ultra-dense deployment of eNBs in an area, there may be a requirement to backhaul the humongous UE data traffic between the eNBs and the EPC. However, wired infrastructure (fiber or the like) conventionally used for the backhaul link between the eNB and the EPC may not be always available and if it does, it requires high cost of deployment and maintenance. Hence, it is not easy to address such requirements. Multi-hop Wireless Relays (also called Multi-hop Relays) can be used to alleviate this issue and address the requirement.

Multi-hop wireless relaying facilitates a wide service area to the covered UEs dynamically and on-demand under diverse network topology. Further, in the multi-hop relaying, a single link with poor channel quality can be divided into a plurality of links with better channel quality. Thus, each link may provide higher transmission rate by further achieving better QoS and spectrum efficiency.

FIG. 1C is an example diagram illustrating the LTE network supporting multi-hop relaying. The LTE network supporting the multi-hop relaying includes an eNB, at least one Relay Node (RN) and at least one UE. The UE can communicate with the RN, and the RN can connect wirelessly to its super-ordinate RN or the eNB and forward/receive the UE data traffic over a wireless backhaul. Thus, a need for backhauling UE data traffic via a wired network link can be eliminated. In addition, as the RNs do not require their wired backhauls and are often less sophisticated than the full functional eNBs, the RNs are less expensive to deploy and operate than the CNBs.

FIG. 1D is an example diagram illustrating typical 3GPP architecture of the LTE network supporting the multi-hop relaying. As illustrated in FIG. 1D, the LTE network includes at least one UE, the eNB and the EPC. Further, a RN and a Donor eNB (DeNB) are included in the typical 3GPP architecture of the LTE network for supporting the multi-hop relaying. The DeNB is a modified eNB that provides functionalities to the RN for the MME and the SGW of the EPC over a S1 interface and other eNBs over an X2 interface, in addition to the functionality of eNBs. Initially, the RN acts as a UE and connects to the DeNB over a Uu radio interface/LTE radio interface. Once the RN connects to the DeNB, the RN uses a Un radio interface to communicate with the DeNB. The RN utilizes the Un radio interface for both S1 and X2 communications to the DeNB. The RN acts as an eNB and uses the Uu interface to communicate with the UEs under its coverage. Therefore, the RN has both UE and eNB characteristics. As a UE, the RN is connected to its own MME and SGW through the DeNB. In this case, the S1 and X2 interfaces terminate in the DeNB. When the RN becomes an eNB, the RN is connected additionally to the MME and the SGW of the UE through the DeNB. The S1 and X2 interfaces for the serving UE terminate in the RN. However, the RN can be bulky since the RN needs to support the Un radio protocols aside of the S1, X2 and Uu protocols. In addition, the Un radio protocols need to support the transfer of S1 and X2 messages as well as General Packet Radio Services (GPRS) Tunneling Protocol (GTP)-U (GTP-U) data. Thus, making the Un interface complicated and challenging to implement.

Similarly, the DeNB appears to the RN as an MME (for S1-MME interface), as an eNodeB (for X2 interface) and as an SGW (for S1-U interface) in addition to a conventional eNB (to RN as well as other UEs connected to it over the radio interface). The DeNB also creates sessions for the RN and manages EPS bearers for the RN, and thus providing SGW/PGW functionality. The RN and DeNB map signaling and data packets to EPS bearers that are set up for the RN. The PGW functions in the DeNB allocate an IP address for the RN for the operation and management functions, which may be different than a SI IP address of the DeNB. Further, from a perspective of the RN, the DeNB appears as if the DeNB is connected directly to the CN, since the DeNB provides proxy functionalities and also appears as an eNodeB for X2 towards the RN. From a perspective of the EPC, the relay cells appear as if they belong to the DeNB. However, the DeNB can be a bulky modification of the eNB, since the DeNB needs to provide proxy functionalities of the CN (MME, SGE and PGW) in addition to the regular eNB functionality. The DeNB also needs to pass UE-specific S1 and X2 signaling messages, and GTP data packets, between the S1/X2 interfaces associated with the RN and the S1/X2 interfaces associated with other network nodes. Further, the RN needs to communicate directly to the DeNB over the Un interface for relaying. Thus, a multiplicity of DeNBs is required for different relay paths, which make the wireless communication network economically inefficient.

In addition, the typical 3GPP architecture of the LTE network for multi-hop communications can support only two-hop relaying. Therefore, the multi-hop operation is not possible. Further, the architecture considers neither UE mobility between different RNs nor RN mobility between different DeNBs. Thus, the architecture supports only an operator deployed, stationary-type and single-hop RN. This LTE relay network based solution can be extended to 5G Relay architecture, where the Relay and Proxy nodes are communicating through the 5G network provided IP connectivity.

Different wireless technologies that can be used by multi-RAT relays are, but not limited to, 5G-NR, LTE, WLAN, non-terrestrial access technologies like satellite, Uncrewed Aerial Vehicle (UAV), High-Altitude Platform Station (HAPS), terahertz communication, and so on. Coexistence of such multiple RAT types would be instrumental in supporting diverse set of use cases for beyond 5G networks.

Hence, there is a need in the art for solutions which will overcome the above mentioned drawback(s), among others.

### OBJECTS

The principal object of embodiments herein is to disclose methods and systems for interchangeably using 5G NR, LTE eNB and Wireless Local Area Network (WLAN) technologies for access and backhaul links in 5G and beyond networks, which provides greater flexibility for the operators to use non-identical radio technology(ies) for access and backhaul, independent of the backhaul technology used.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIGS. 1A and 1B illustrate a wireless communication network in compliance with a standard 3rd Generation Partnership Project (3GPP) specification, wherein the wireless communication network can be a 5G network, according to existing arts;

FIG. 1C is an example diagram illustrating an LTE network supporting multi-hop relaying, according to existing arts;

FIG. 1D is an example diagram illustrating typical 3GPP architecture of a LTE network, according to existing arts;

FIGS. 2A and 2B depict a Fifth Generation (5G) network architecture depicting the implementation of relays in the same, according to embodiments as disclosed herein;

FIG. 3 depicts an example hybrid Multi-RAT scenario when a combination of various RATs can be used for access and backhauling, according to embodiments as disclosed herein;

FIGS. 4A and 4B depict example scenarios, wherein different RATs are used for access and backhaul in wireless communication networks, according to embodiments as disclosed herein;

FIG. 5 depicts an example scenario, wherein the network is using WLAN (Wi-Fi) as access and 5G-NR backhaul-based Multi-RAT relay architecture with N3IWF as the proxy node, according to embodiments as disclosed herein;

FIG. 6 depicts an example scenario, wherein the network is using WLAN (Wi-Fi) as access and 5G-NR backhaul based Multi-RAT relay architecture using a Wi-Fi gateway as the proxy node, according to embodiments as disclosed herein; and

FIG. 7 depicts an example scenario, wherein the network comprises one or more NTN based relay nodes, according to embodiments as disclosed herein.

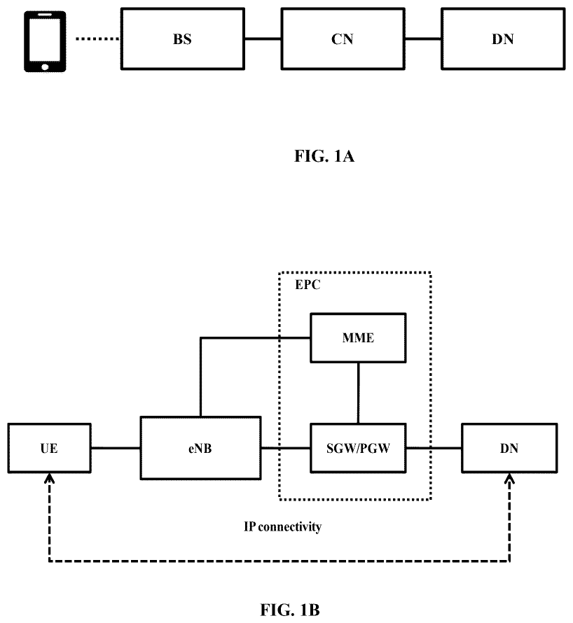

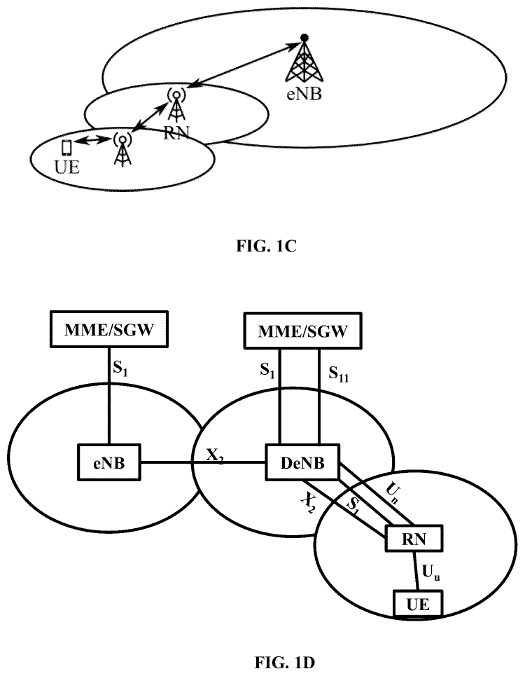

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

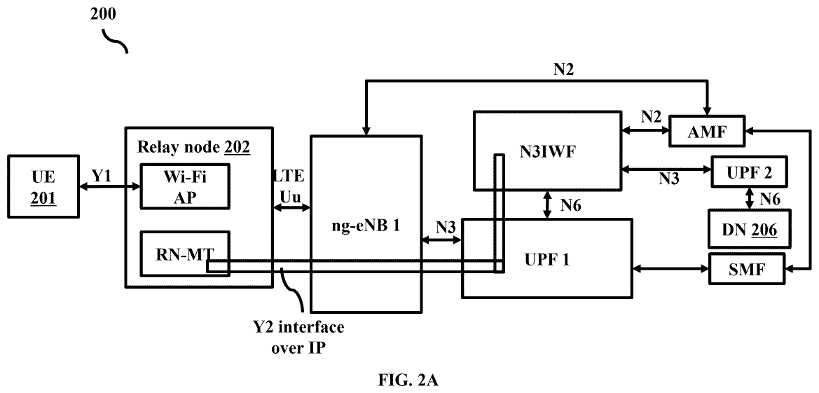

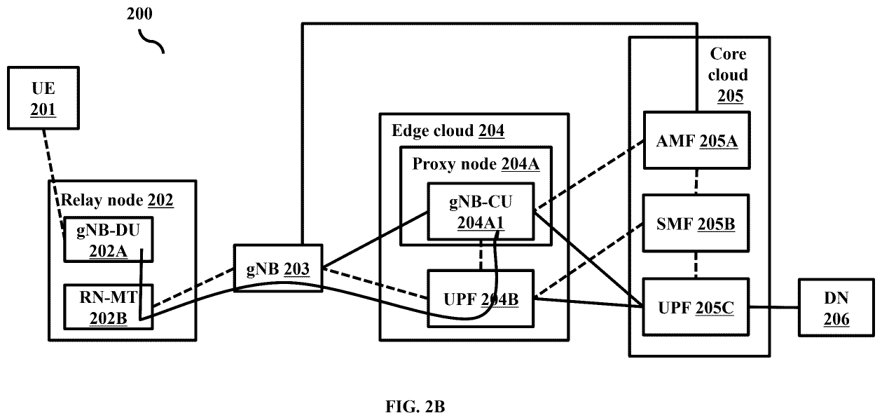

The embodiments herein achieve methods and systems for interchangeably using 5G NR, LTE eNB and Wireless Local Area Network (WLAN) technologies for access and backhaul links in the 5G relay architecture. Referring now to the drawings, and more particularly to FIGS. 2 through 7, where similar reference characters denote corresponding features consistently throughout the figures, there are shown embodiments.

Embodiments herein disclose methods and systems for interchangeably using 5G NR, LTE eNB and Wireless Local Area Network (WLAN) technologies for access and backhaul links in the 5G relay architecture, which provides greater flexibility for the operators to use any radio technology for access, independent of the backhaul technology used. Different wireless technologies that can be used by multi-RAT relays are 5G-NR, LTE, WLAN, non-terrestrial access technologies like satellite, Uncrewed Aerial Vehicle (UAV), High-Altitude Platform Station (HAPS), terahertz communication, and so on.

FIGS. 2A and 2B depict the Fifth Generation (5G) network architecture. A wireless communication network 200 (as depicted in FIGS. 2A and 2B) can be split into a radio stack component (for example, if the UE 201 is using 5G NR, the radio stack component can be a gNB-DU 202A, as shown in the example in FIGS. 2A and 2B), and a core interface stack component (for example, if the UE 201 is using 202A as a radio stack component, then 204A1 is the core interface stack component), wherein the radio stack component can support UE connectivity. The core interface stack can connect with a core network. The stacks are placed in different nodes, i.e., a relay node, and a proxy node, wherein two nodes communicate using the 5G network provided IP connectivity, hence they don't necessarily need to be collocated.

The network 200, as depicted, comprises at least one User Equipment (UE) 201, at least one relay node 202, a gNodeB (gNB) 203, an edge cloud 204, a core cloud 205, and a Data Network (DN) 206. In an embodiment herein, the UE 201 can communicate with the relay node 202 through a NR-Uu interface.

The relay node 202 further comprises at least one gNB-DU (gNB-distributed unit) 202A (i.e., the radio stack), and at least one Relay Node-Mobile Termination (RN-MT) 202B (i.e., a complete UE stack). In an embodiment herein, the relay node 202 can communicate with the gNB 203 through a NR-Uu interface.

The edge cloud 204 can comprise a proxy node 204A, and a first User Plane Function (UPF) 204B. The proxy node 204A comprises a gNB-Centralized Unit (gNB-CU) 204A1 (i.e., the core interface network stack). In an embodiment herein, the gNB-CU 204A1 and the UPF 204B can communicate with each other over an N6 interface. In an embodiment herein, the gNB 203 and the gNB-CU 204A1 can communicate with each other over an Xn interface. In an embodiment herein, the gNB 203 and the first UPF 204B can communicate with each other over an N3 interface. The IP connectivity between the relay node 202 and the proxy node 204A is facilitated through a 5G System provided PDU (IP) connectivity service established using the RN-MT 202B. In an embodiment herein, the gNB-DU 202A can communicate with the gNB-CU 204A1 over a PDU (IP) connectivity service between the relay node 202, and the proxy node 204A (for example, an F1 interface).

The core cloud 205 can comprise an Access and Mobility Management Function (AMF) 205A, a 5G Session Management Function (SMF) 205B, and a second UPF 205C. In an embodiment herein, the gNB 203 and the AMF 205A can communicate with each other over an N2 interface. In an embodiment herein, the gNB 203 and the second UPF 205B can communicate with each other over an N3 interface. The gNB-CU 204A1 and the AMF 205A can communicate with each other over an N2 interface. In an embodiment herein, the gNB-CU 204A1 and the second UPF 205C can communicate with each other over an N3 interface. In an embodiment herein, the first UPF 204B and the SMF 205B can communicate with each other over an N4 interface. In an embodiment herein, the first UPF 204B and the second UPF 205C can communicate with each other over an N9 interface. In an embodiment herein, the second UPF 205C and the DN 206 can communicate with each other over an N6 interface.

Embodiments herein enable different RATs to be used for access and backhaul in wireless communication networks (i.e., provides interoperability), wherein a first RAT can be used for access, and a second RAT can be used for backhaul.

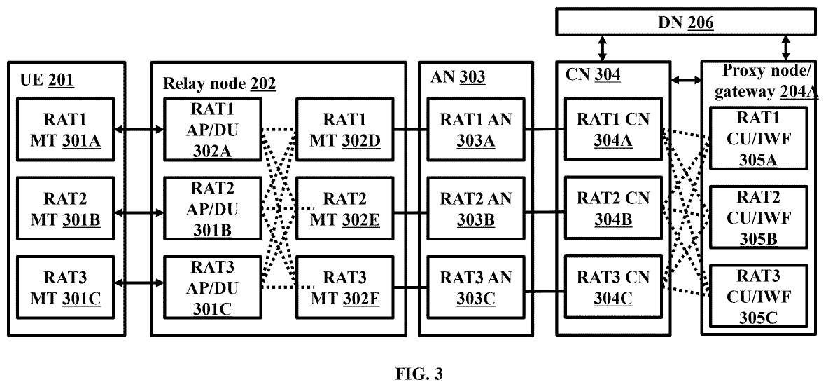

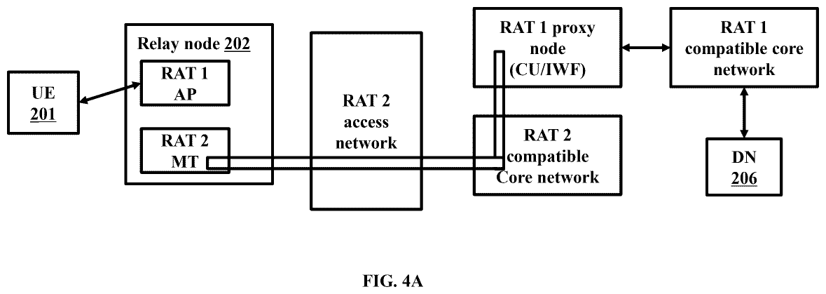

Embodiments herein support hybrid relay architecture(s) for multi-RAT scenarios, which can be implemented/deployed based on available RAT infrastructure. FIG. 3 depicts an example hybrid Multi-RAT scenario when a combination of various RATs can be used for access and backhauling. Multi-RAT scenarios can be logically extended to a hybrid multi-RAT architecture in which UEs, relay nodes, access network, backhaul network, core network, and proxy nodes can support different radio access technologies. As depicted in FIG. 3, the architecture comprises one or more UEs 201, one or more relay nodes 202, an Access Network (AN) 303, a Core Network (CN) 304, the proxy node/gateway 204A, and the data network (DN) 206. The UEs 201, the one or more relay nodes 202, the AN 303, the CN 304, and the proxy node/gateway 204A each comprise a plurality of RATs. For example, as depicted in FIG. 3, the UE 201 can have one or more radio interfaces for single or multiple RATs. Note that there can be additional RATs; only three RAT1 301A, RAT2 301B, and RAT3 301C are depicted for representational purposes. Similarly, all other components (as disclosed herein) can be compliant with single or multiple RATs. In an example, as depicted in FIG. 3, the UE 201 can connect to the relay node 202 over the radio interface RAT2 301B, and the relay node 202 can connect to the proxy node/gateway 204A (RAT2) through backhaul connectivity of any other available RAT (let's assume RAT3). Further, the proxy node (RAT2) 204A can provide connectivity to the data network 206 through a core compliant with a RAT (RAT2). If it is a gateway (based on the type of RAT), the proxy node/gateway 204A can provide direct connectivity to the data network 206.

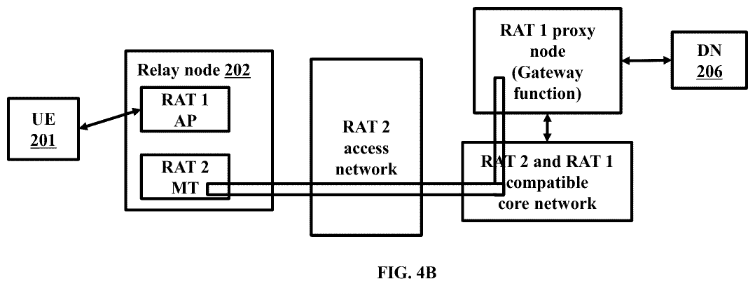

FIGS. 4A and 4B depict example scenarios, wherein different RATs are used for access and backhaul in wireless communication networks. FIGS. 4A and 4B show how various RAT types can co-exist to provide a workable relay solution. Two use cases of RAT interoperability scenarios are shown in FIGS. 4A and 4B. The UE 201 connects to the relay node 202 over the RAT 1 radio interface (as shown in FIG. 4A), and the relay node 202 connects to the proxy node 204A via RAT 2 based backhaul connectivity. Here, the relay node 202 comprises a ‘RAT 1 radio access protocol stack’ towards the UE and a ‘RAT 2 MT stack’ towards a core network for the backhaul access, which facilitates IP connectivity with the RAT 1 proxy node 204A. Initially, PDU (IP) connectivity service is established between the MT stack of the relay node 202 (acting as a UE for the RAT2 backhaul access network) and the RAT 1 Proxy node. The UE 201 then connects to the RAT 1 Proxy node 204A through the relay node 202 (via RAT 2 access and core network). Further, the RAT 1 proxy node 204A extends UE connectivity to the data network 206 through a RAT 1 compatible core network. If the same core network is compatible with both RAT 1 and RAT 2, the RAT1 Proxy node 204A provides connectivity to the data network 206 through the same core as shown in FIG. 4B. An example of this scenario could be the 5G core which supports RAT types like WLAN, LTE and 5G NR.

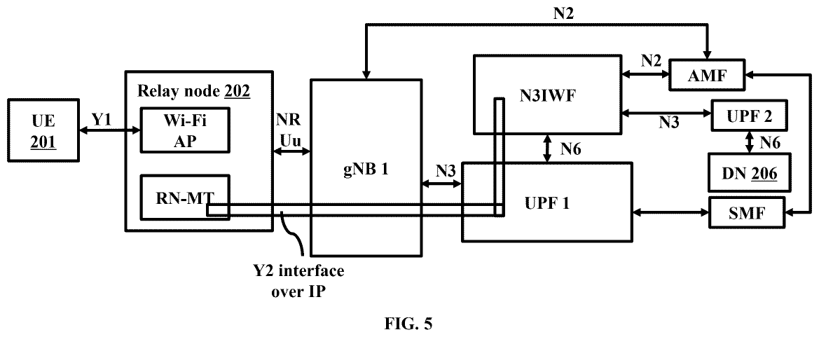

FIG. 5 depicts an example scenario, wherein the network is using WLAN (Wi-Fi) as access and 5G-NR backhaul-based Multi-RAT relay architecture with N3IWF as the proxy node 204A. The relay node 202 comprises a Wireless Access Point (Wi-Fi AP). The Wi-Fi AP can provide wireless connectivity to one or more UEs 201, and can enable the UEs 201 to reach the 5G core via Non-3GPP InterWorking Function (N3IWF). The RN-MT 202B of the relay node 202 uses 5G-NR as a backhaul, and connects to the N3IWF via a 5G network (gNB1+UPF1) by establishing a PDU session. The PDU (IP) connectivity service facilitates Y2 interface connectivity between the Wi-Fi AP, and the N3IWF. In an embodiment herein, the PDU session can also encapsulate the traffic for all the UEs 201 connected to the relay node 202, wherein the UEs 201 can connect to the data network 206 (via UPF2) using connectivity between the relay node 202 (RN-MT 202B) and the N3IWF.

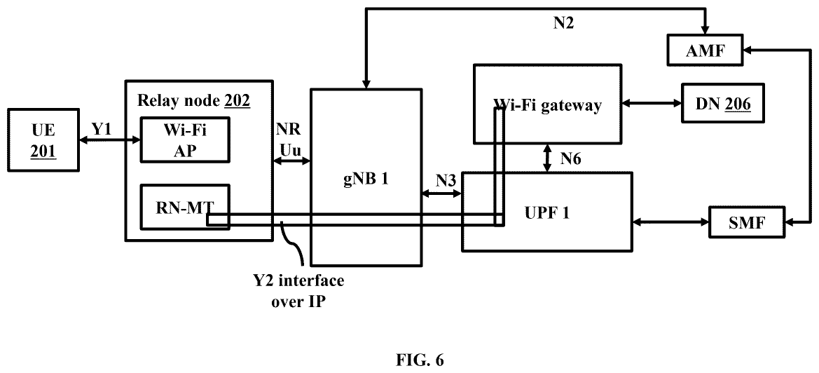

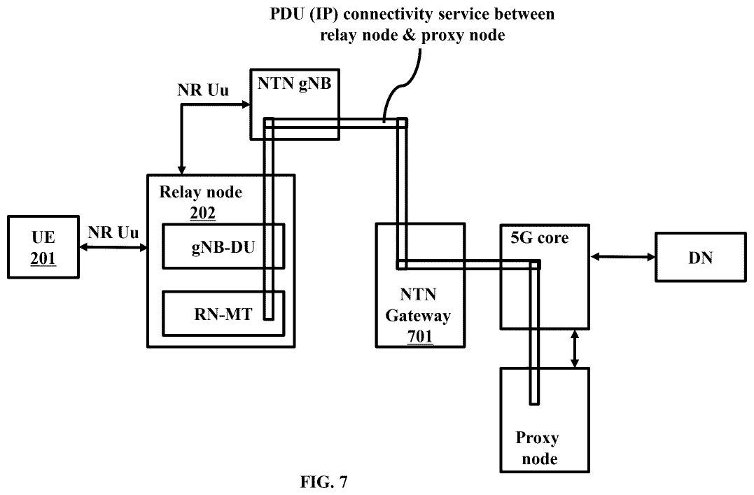

FIG. 6 depicts an example scenario, wherein the network is using WLAN (Wi-Fi) as access and 5G-NR backhaul based Multi-RAT relay architecture using a Wi-Fi gateway as the proxy node. A WLAN (Wi-Fi) gateway 601 can be used in place of the N3IWF, which can provide direct connectivity to the data network 206. The UE 201 is connected to the data network 206 through the following path: Relay node⇒gNB1⇒UPFI⇒WLAN (Wi-Fi) gateway. Here, the 5G network only provides backhaul connectivity, and the WLAN (Wi-Fi) gateway provides direct connectivity to the data network.

FIG. 7 depicts an example scenario, wherein the network comprises one or more NTN based relay nodes. The UE 201 connects to the relay node 202 over the NR Uu radio interface, wherein the relay node 202 comprises a standard gNB-DU with an additional Uu interface radio stack to support Satellite-UE functionality. The proxy node 204A hosts a standard gNB-CU. The relay node 202 connects with the proxy node 204A using PDU (IP) connectivity service established through satellite access and 5G core enables IP connectivity via NTN (satellite access network) to establish the F1 logical interface between the gNB-DU of the relay node 202, and the gNB-CU of the proxy node 204A.

NTN (satellite access network) connectivity to the 5GC is provided via an NTN Gateway 701. The satellite-based NG-RAN architectures can be an architecture, as defined in 3GPP TR 38.821, such as, but not limited to, transparent satellite-based NG-RAN architecture, regenerative satellite-based NG-RAN architecture, and so on. FIG. 7 shows the architecture with respect to a regenerative (gNB onboard) payload. However, any of the other satellite-based NG-RAN architecture (as defined in 3GPP TR 38.821) can be integrated with this architecture. The main advantage is that UEs need not be a satellite-UE, they are connected to the satellites via the relay node 202.

The relay node (satellite-RN-MT) 202 can experience intra-satellite or inter-satellite handover that occurs between satellite beams or between two different satellites and are different from the conventional handovers as seen in the case of terrestrial Base Stations. The mobility of UEs 201 in the proposed NTN based relay solution will work in the same way as detailed in IN201921027924. In an embodiment herein, the relay nodes can be deployed as a stationary node, In an embodiment herein, the relay nodes can be deployed as moving nodes on the ground. In an embodiment herein, the relay nodes can act as an aerial node (e.g. UAV) that will enable connection of standard UEs with the 5GC through satellite access. Satellite access link provides backhaul connectivity to the relay nodes, hence no other additional infrastructure and interface modules are required.

The embodiments disclosed herein can be implemented through at least one software program running on at least one hardware device and performing network management functions to control the network elements. The elements include blocks which can be at least one of a hardware device, or a combination of hardware device and software module.

The embodiment disclosed herein describes methods and systems for interchangeably using 5G NR, LTE eNB and Wireless Local Area Network (WLAN) technologies for access and backhaul links in the 5G relay architecture. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

We claim:

1. A wireless communication network (200) comprising:
at least one relay node (202);
an edge cloud (204);
a core cloud (205); and
a Data Network (DN) (206),
wherein the network (200) uses different Radio Access Technologies (RATs) for access, and backhaul.

2. The wireless communication network, as claimed in claim 1, wherein the relay node (202) further comprises at least one radio stack (202A), and at least one complete Relay Node-Mobile Termination (RN-MT) stack (202B), wherein at least one radio stack can support connectivity with at least one User Equipment (201).

3. The wireless communication network, as claimed in claim 2, wherein at least one radio stack (202A), and the RN-MT stack (202B) can:
use different RATs for access, and backhaul; and
use the same RATs for access, and backhaul.

4. The wireless communication network, as claimed in claim 1, wherein the at least one relay node (202) is in communication with the edge cloud (204) via a gNB (203).

5. The wireless communication network, as claimed in claim 1, wherein the edge cloud (204) further comprises a proxy node (204A), and a first User Plane Function (UPF) (204B), wherein Internet Protocol (IP) connectivity between the relay node (202) and the proxy node (204A) is facilitated through a 5G System provided PDU (IP) connectivity service established using the at least one complete RN-MT stack (202B).

6. The wireless communication network, as claimed in claim 5, wherein the proxy node (204A) comprises a core interface network stack (204A1), wherein the core-interface network stack (204A1) connects with a core network.

7. The wireless communication network, as claimed in claim 1, wherein a first RAT can be used for access, and a second RAT can be used for backhaul.
